(19) United States
(12) Patent Application Publication
(10) Pub. No.: US 2004/0016264 A1
(43) Pub. Date: Jan. 29, 2004

(54) Apparatus for drawing an optical fiber and method for controlling feed speed of an optical fiber preform

(76) Inventors: Myung-Sop Lee, Kumi-shi (KR); Ki-Tae Jung, Kumi-shi (KR); Jae-Hong Park, Kumi-shi (KR)

Correspondence Address: CHA & REITER, LLC, 210 ROUTE 4 EAST, PARAMUS, NJ, 07652, US

(21) Appl. No.: 10/619,995

(22) Filed: Jul. 15, 2003

(30) Foreign Application Priority Data
Jul. 29, 2002 (KR) 2002-44754

(51) Int. Cl. C03B 37/07

(52) U.S. Cl. 65/377; 65/435; 65/381

(57) ABSTRACT

An apparatus for drawing an optical fiber and a method for controlling the feed speed of an optical fiber preform whereby the drawing speed of an optical fiber is stabilized to keep the size of the outer diameter uniform. The capstan speed is determined based on the outer diameter of the optical fiber. When the capstan speed is out of a target speed range, the preform feed speed is controlled to bring the capstan speed into the target range. A control unit includes a calculation unit for receiving a drawing speed signal output from the capstan and calculating a feed speed of the perform. The control unit regulates the outer diameter of the optical fiber by regulating the speed of the capstan according to a signal received from the outer diameter measurement unit indicating a change in the outer diameter of the optical fiber.

### CLAIM OF PRIORITY

This application claims priority to an application entitled “Apparatus for drawing an optical fiber and method for controlling the feed speed of an optical fiber perform,” filed in the Korean Intellectual Property Office on Jul. 29, 2002 and assigned Ser. No. 2002-44754, the contents of which are hereby incorporated by reference.

### BACKGROUND OF THE INVENTION

1. Field of the Invention

The present invention relates to an apparatus for drawing an optical fiber and a method for controlling the feed speed of an optical fiber. More particularly, the method relates to a preform whereby the drawing speed of the optical fiber is stabilized to keep uniform the outer diameter of the optical fiber.

2. Description of the Related Art

Generally, when an optical fiber is drawn, the length of the outer diameter of the optical fiber is controlled using its drawing speed. FIG. 1 is a view showing the basic configuration of an apparatus for drawing the optical fiber.

As shown FIG. 1, the apparatus includes an optical fiber preform feeder 2, a melting furnace 3 for heating and melting an optical fiber preform 1, an outer-diameter measurement unit 4 for measuring the outer diameter of an optical fiber 6, an optical-fiber coating unit 5, a capstan 7, a spool 8 for winding the optical fiber 6, and a PID control unit 9. The preform feeder 2 transfers an amount of the optical fiber preform 1 to the melting furnace 3 equal to the amount of the drawn optical fiber 6. The optical-fiber coating unit 5 performs a coating process for the optical fiber 6 to protect it from humidity, abrasion, contaminents, etc. The turning of the capstan 7 pulls the optical fiber 6 using a frictional force so as to keep a uniform outer diameter thereof.

Here, the melting temperature of the optical fiber preform is at least set as the melting temperature of furnace 3, and the feed speed of the optical fiber preform is fixed. The melting rate of the optical fiber is the same as the drawing rate of the optical fiber. Therefore, the drawing speed of the optical fiber is given as in the following equation 1.

Df=Dp√(Sp/(Sf×1000) Equation 1

Wherein: (Df(mm): outer diameter of drawn optical fiber, Sf(m/min): drawing speed of the optical fiber, Dp(mm): outer diameter of preform, Sp(mm/min): feed speed of preform).

The optical-fiber drawing process is performed to obtain an optical fiber having an outer diameter as uniformly sized as possible so as to minimize the optical attenuation of the optical fiber and improve the tension thereof.

Conventionally, in order to keep the outer diameter of the optical fiber uniform, the speed of the capstan is controlled according to the variation of the melting rate of the preform fiber. This conventional control method is summarized as followed, referring to FIG. 2.

FIG. 2 is a flowchart illustrating the conventional control process. First, after a signal representing the outer diameter of the optical fiber is received (S21), a determination is made on whether to perform an automatic control (S22). When the determination result is not to perform the automatic control (S23), a signal is outputted to fix the speed of the capstan (S24). When the determination result is to perform the automatic control (S25), the signal of the outer diameter is checked (S26), and, according to the check result, the speed of the capstan is controlled using the PID control unit (S27).

However, in general, as the optical fiber is exhausted, the preform becomes shorter in length (as shown in FIG. 3), and the preform-melting heat is accumulated inside the preform. The accumulation of heat causes changes in the melting rate of the preform, such that it increases the melting rate of the preform. The drawing speed is also changed in order to keep uniform the outer diameter of the optical fiber, with the increased melting rate of the preform.

FIGS. 3a, 3b, and 3b are views showing the shapes of a normal preform, the preform when the inner part of the preform begins to be exhausted, and the preform when only the innermost part remains, respectively. Here, reference numerals 31 and 32 indicate a joint tube and the preform, respectively.

FIG. 4 is a graph showing the drawing speed change of the optical-fiber in the prior art, when the inner part of the preform is exhausted. Here, the vertical and horizontal axes represent the normalized Δ drawing speed and the optical-fiber drawing time (min), respectively.

As shown in FIG. 4, the slope of the drawing-speed change is not so steep for 25 minutes after the exhaustion of the inner part begins. However, as the exhaustion continues, the drawing speed sharply increases. Only when the innermost part remains (as shown in FIG. 3c), the drawing speed sharply decreases due to an insufficient amount of the preform, consequently finishing the optical-fiber drawing process.

Therefore, when the optical-fiber outer diameter is controlled using only the capstan (as in the prior art), the following problems occur.

Firstly, the optical fiber increasingly becomes less and less straight, thereby raising the defective rate of the optical characteristic of the optical fiber. Secondly, the variation of the drawing speed leads to an increase of the non-uniformity in the outer diameter of the optical fiber or the protection coating. Thirdly, continuous observation is needed to control the feed speed, and therefore the utilization of working-manpower is not efficient.

### SUMMARY OF THE INVENTION

Therefore, the present invention has been made in view of the above problems of the prior art. It is, therefore, an object of the present invention to provide an apparatus for drawing an optical fiber and a method for controlling the feed speed of an optical fiber preform which allows keeping of an uniform drawing speed of the optical fiber, even when there is a variation in the amount of heat inside the preform due to heat accumulated therein during the drawing process of the optical fiber.

It is another object of the present invention to provide an apparatus for drawing an optical fiber and provide a method for controlling the feed speed of an optical fiber preform so as to allow stabilization of the optical characteristic of an optical fiber drawn from the inner part of the preform.

In accordance with a first aspect of the present invention, the above and other objects can be accomplished by the provision of an apparatus for drawing an optical fiber comprising: a melting furnace for melting an optical fiber preform; a preform feeder for feeding the preform into the melting furnace; a capstan for drawing an optical fiber by applying a tension force to the preform; an outer diameter measurement unit for measuring an outer diameter of the drawn optical fiber; and a control unit for controlling the outer diameter of the optical fiber, wherein the control unit includes a calculation unit for receiving a drawing speed signal outputted from the capstan and calculating the feed speed of the preform.

Preferably, the calculation unit calculates a slope of the drawing speed during an arbitrary period before the present period, obtains an expected drawing speed of an arbitrary time later by using the calculated slope, and then estimates a compensation value according to a difference between the present drawing speed and a target drawing speed as well as a compensation value according to a difference between the present drawing speed and the expected drawing speed of the arbitrary time later, and calculates the preform feed speed based on the estimated compensation values.

In accordance with another aspect of the present invention, there is provided a method of controlling a feed speed of an optical fiber preform, comprising the steps of: storing data of a drawing speed of an optical fiber at intervals of a predetermined sampling period; checking whether the present drawing speed is in a stable drawing-speed range or an unstable drawing-speed range and beginning an automatic control of a preform feed speed when the check result is that it is in the unstable drawing-speed range; obtaining a recent drawing-speed change tendency based on the stored drawing speed data; obtaining an expected deviation of the drawing speed of an arbitrary time later based on the recent drawing-speed change tendency; obtaining a compensation value of the preform feed speed based on the expected value; obtaining a modification value of the preform feed speed by modifying the compensation value; and adding or subtracting the modification value of the preform feed speed to or from a target speed.

Preferably, during the step of adding or subtracting the modification value of the preform feed speed to or from the target speed, when the modification value of the preform feed speed is in a predetermined range from a negative predetermined value to a positive predetermined value, the present feed speed is changed by adding the negative or positive predetermined value to the present feed speed, and processes of changing the present feed speed and determining the range of modification value are repeated at intervals of a predetermined time until the feed speed reaches the target speed, so as to prevent an abrupt change of the feed speed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the basic configuration of an apparatus for drawing the optical fiber;

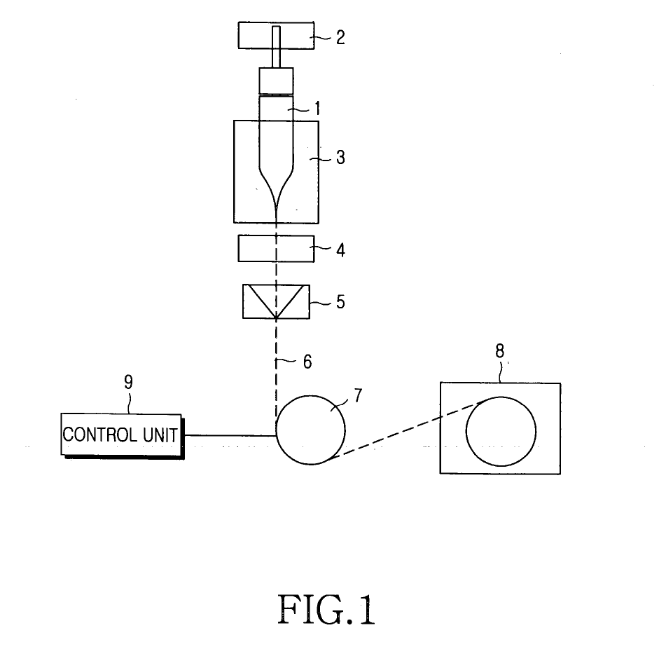

FIG. 2 is a flowchart showing the conventional process for controlling the outer diameter of the optical fiber;

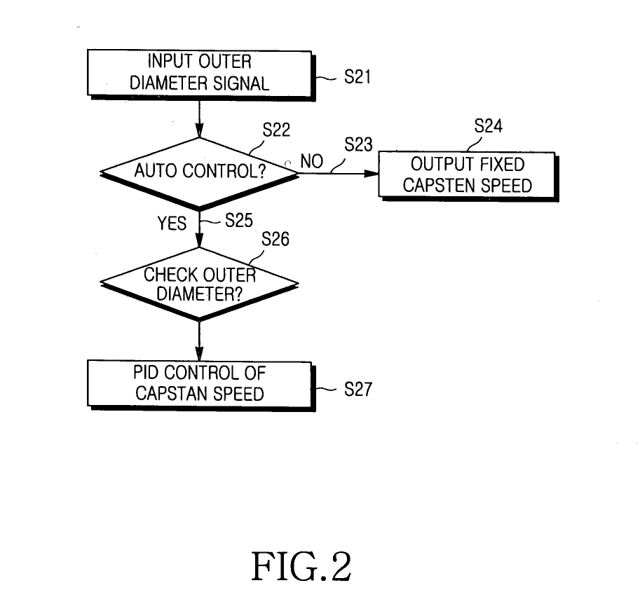

FIGS. 3a, 3b, and 3b are views showing shapes of the preform;

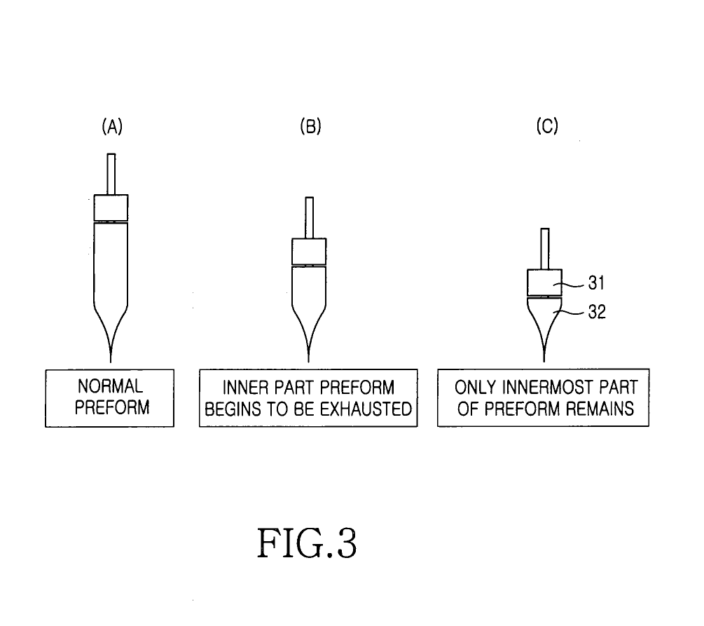

FIG. 4 is a graph showing the conventional change of the optical-fiber drawing speed in the prior art, when the inner part of the preform is exhausted;

FIG. 5 is a view illustrating signals flowing in an apparatus for drawing an optical fiber according to the present invention;

FIG. 6 is a flowchart showing the process of controlling the feed speed of optical fiber preform according to the present invention;

FIG. 7 is a flowchart showing a process of classifying and transmitting a preform feed speed according to the present invention;

FIG. 8 is a graph illustrating a loss characteristic with respect to the drawing speed; and

FIG. 9 is a graph illustrating the drawing speed change when the inner part of the preform is exhausted.

### DETAILED DESCRIPTION OF THE PREFERRED EMBODIMENTS

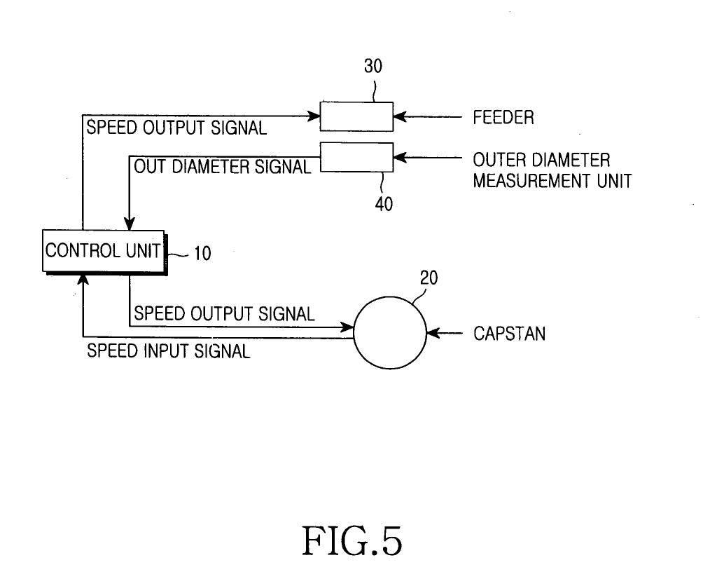

Now, a preferred embodiment of the present invention will be described in detail with reference to FIGS. 5 to 8. In the drawings, the same or similar elements are denoted by the same reference numerals even though they are depicted in different drawings. For the purposes of clarity and simplicity, a detailed description of known functions and configurations incorporated herein will be omitted when it may make the subject matter of the present invention unclear.

FIG. 5 is a view illustrating signals flowing in an apparatus for drawing an optical fiber according to the present invention.

Similar to the prior art, the apparatus includes a melting furnace, a preform feeder, a measurement unit of an optical-fiber outer diameter, a coating unit, a capstan, a spool, and a control unit. The following description will be made concentrating on the control unit.

As shown in FIG. 5, the control unit 10 receives a signal representing the drawing speed of an optical fiber from the capstan 20, and calculates the preform feed speed using the received drawing speed signal. The control unit 10 outputs a preform feed-speed signal changed according to the calculated value to change the preform feed speed of the preform feeder 30. The change o f the preform feed speed leads to a change of the rate that the preform enters the furnace to be melted. This causes a change in the outer diameter of the fiber. Upon receipt of the changed outer diameter signal from the outer diameter measurement unit 40 due to the change in diameter, the control unit 10 changes the speed of the capstan to keep a uniform outer diameter, thereby changing the fiber drawing speed.

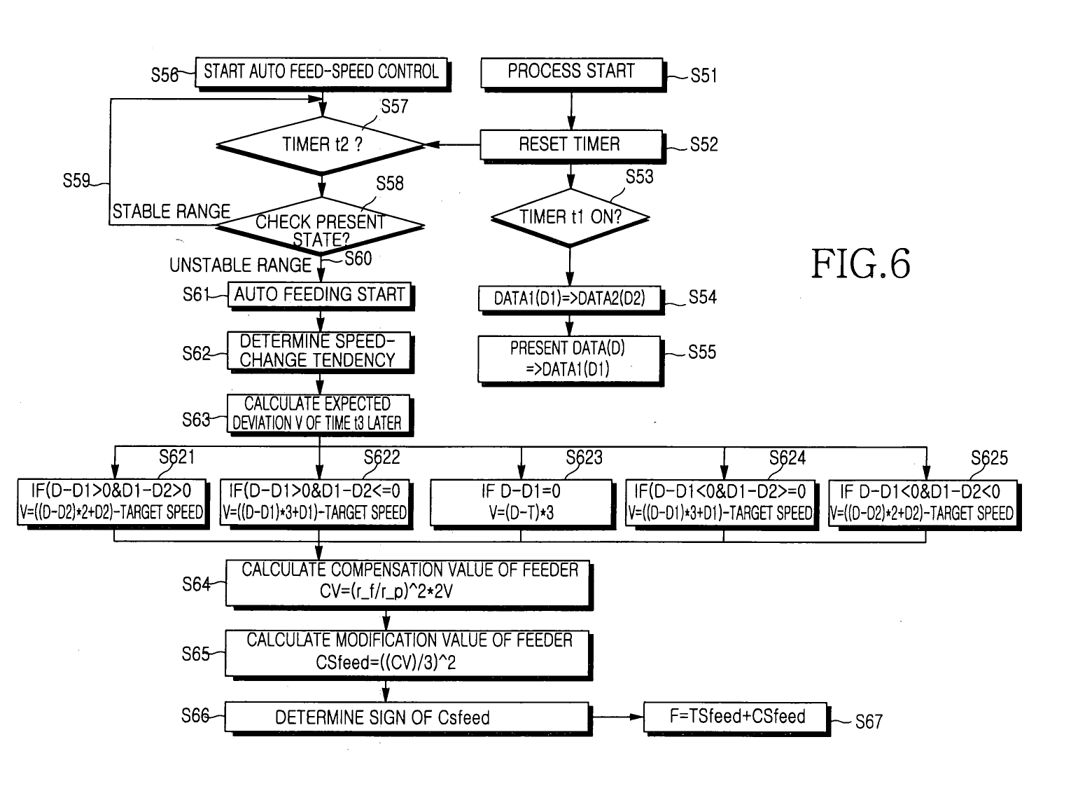

FIG. 6 is a flowchart showing the process of controlling the feed speed of optical fiber preform according to the present invention. Referring to FIG. 6, the control process of the preform feed speed is described as follows.

Upon starting of the fiber drawing process (S51), the timers are reset (S52). Each time a timer of t1 is started (S53), a captan speed data representing the fiber drawing speed is stored (S54, S55). Here, “t1” indicates a sampling time for collecting data.

An actuator for automatically controlling the preform feed speed is pushed to activate the automatic control (S56), and each time a timer of t2 is started (S57), determination is made on whether the present drawing speed is in a stable or unstable drawing speed range (S58). When the determination result is that it is in the stable drawing speed range (S59), the determination of step S58 is repeated each time the timer of t2 is started. At the very time when the determination result is that it is in the unstable speed range (S60), the automatic feed speed control is started (S61).

When the automatic feed speed control is started (S61), the recent drawing-speed variation tendency is calculated (S62). The calculation of the recent drawing-speed variation tendency is performed using the data collected each time the timer of t1 is started. The recent drawing-speed variation tendency is classified into five types, based on three conditions of acceleration, deceleration, and uniform speed, and two different lengths of time for observing the variation tendency. According to its individual speed-variation pattern, the variation tendency is classified into one of five types of acceleration Lt (long-period acceleration: S621), acceleration St (short-period acceleration: S622), uniform speed (S623), deceleration St (short-period deceleration: S624), and deceleration Lt (long-period deceleration: S625).

After the speed variation tendency type has been determined at step (S62), an expected deviation V of a time t3 later is calculated for each tendency type. The expected deviation means a value of the capstan speed of the time t3 later that is estimated based on the present speed-variation tendency. The determination on the tendency type and the calculation of the expected deviation are given in the following table 1.

TABLE 1

| | | Determination | |
|---|---|---|---|
| Speed of t1 ago- | Present Speed- | of Variation | Calculation of |
| Speed of t2 ago | Speed of t1 ago | Tendency | Expected deviation |
| Acceleration | Acceleration | Acceleration Lt | ((D − D2)x2 + D2) |
| (Increased) | Uniform speed | Uniform Speed | D |
| | Deceleration | Deceleration St | ((D − D1)x3 + D1) |
| Uniform speed | Acceleration | Acceleration St | ((D − D1)x3 + D1) |
| (Unchanged) | Uniform speed | Uniform speed | D |
| | Deceleration | Deceleration St | ((D − D1)x3 + D1) |
| Deceleration | Acceleration | Acceleration St | ((D − D1)x3 + D1) |
| (Decreased) | Uniform speed | Uniform speed | D |
| | Deceleration | Deceleration Lt | ((D − D2)x2 + D2) |

(D: present drawing speed data, D1: drawing speed data of t1 time ago, D2:drawing speed data of t2 time ago)

After the expected deviation is calculated (S63), compensation value CV of the preform feed speed is calculated based on the following equation 2 (S64).

$$\begin{matrix}CV = {( Df / Dp )}^{2} \times 2 V \\ = {[ \{ Dp √ ( Sp / ( Sf \times 1000 ) ) \} / Dp ]}^{2} \times 2 V \\ = ( Sp \times 2 V ) / ( Sf \times 1000 )\end{matrix} \qquad Equation 2$$

(Df: outer diameter of drawn optical fiber, Dp: outer diameter of preform, Sf: optical-fiber drawing speed, CV: compensation value of preform feed speed).

However, as the drawing speed becomes more distant from the stable drawing-speed range, the compensation value CV of preform feed speed (S65) must be modified, so as to accelerate the drawing speed toward the stable range. That is, after the initial compensation value CV of preform feed speed is calculated (S64), the modification value CS of preform feed speed is calculated based on the following Equation 3 (S65).

CS=(CV/3)² Equation 3

(CS: Modification value with respect to distance from the stable range, CV: compensation value of preform feed speed).

After the modification value CS of preform feed speed is calculated (S65), a determination is made on whether the sign of the modification value CS is positive or negative (S66). In other words, a determination is made on whether to subtract or add the calculated modification value CS. Here, the determination on the sign of the modification value CS is made such that the speed of the capstan becomes closer to the stable drawing-speed range.

Finally, a final preform feed speed is obtained by adding or subtracting the calculated modification value CS to or from a target speed TS according to the determination on the sign so as to maintain the stable range and the preform in the steady state.

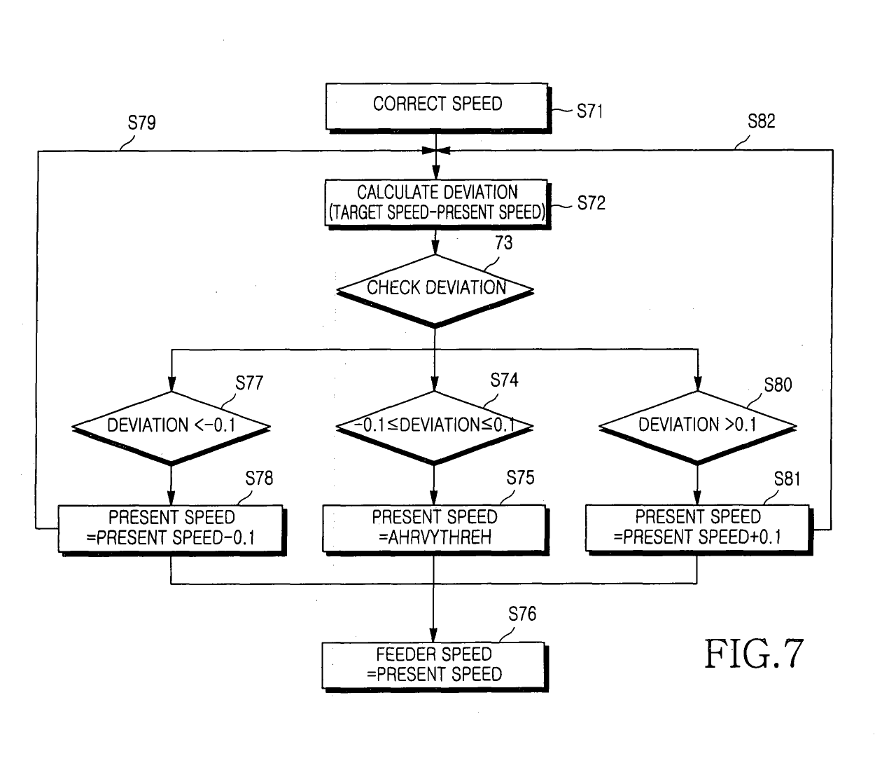

Here, when the capstan speed is sharply increased or decreased, its sharply-varied speed input causes variation in the outer diameter of the optical fiber. In order to prevent the variation in the outer diameter, the feed speed is classified to be transmitted according to the procedure of the flowchart shown in FIG. 7.

As shown in FIG. 7, for performing a feed speed correction (S71), the present speed is subtracted from the target speed to calculate a deviation therebetween (S72). Then, a check is made on the deviation (S73). When the check result is that the deviation is in a predetermined range, for example, a range from −0.1 mm/min to 0.1 mm/min (S74), the feed speed is maintained at the present speed because both speeds are alike (S75). If the check result is that the deviation is less than −0.1 mm/min (S77), 0.1 is subtracted from the present speed (S78), and then its result value is transmitted (S79). When the check result is that the deviation is more than 0.1 mm/min (S80), 0.1 is added to the present speed (S81), and then its result value is transmitted (S82). This procedure (from S72 to S76) is repeated such that the present speed comes into a predetermined range from the target speed.

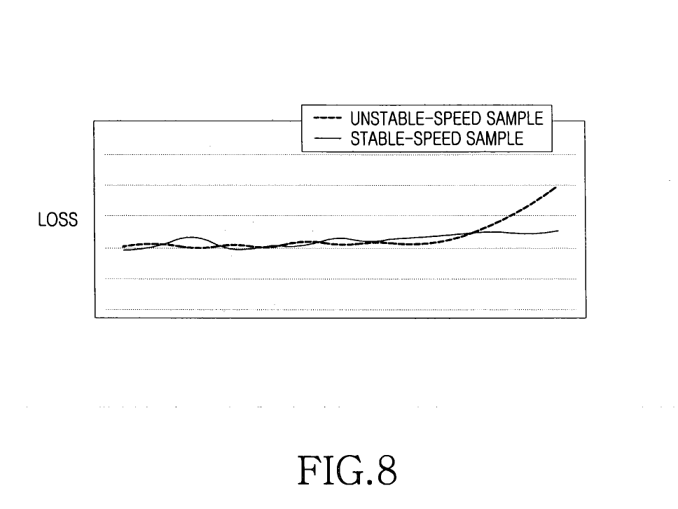

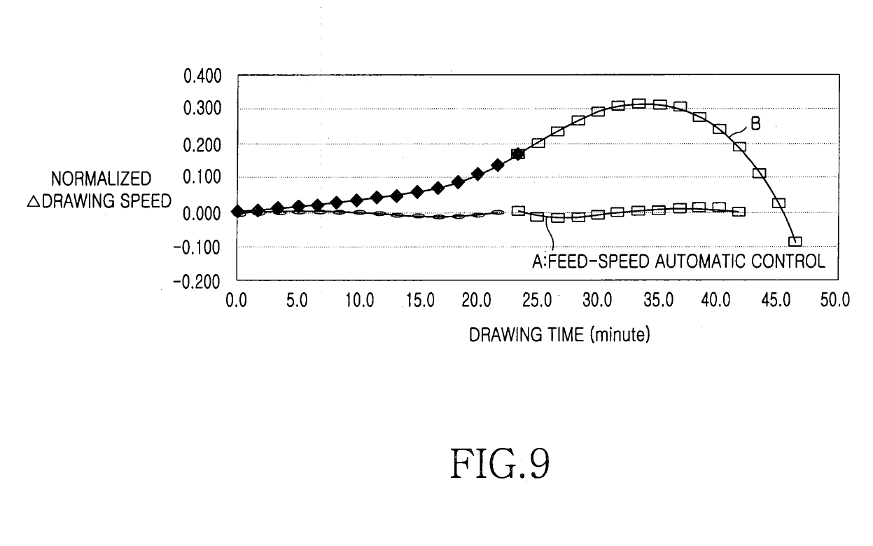

When the feed speed of optical fiber preform is controlled in such a manner, the drawing speed is varied as shown in FIGS. 8 and 9.

FIG. 8 is a graph illustrating a loss characteristic with respect to the drawing speed. As shown in this graph, the loss characteristic in the inner part of the preform is improved when the drawing speed is stable, compared with when it is unstable.

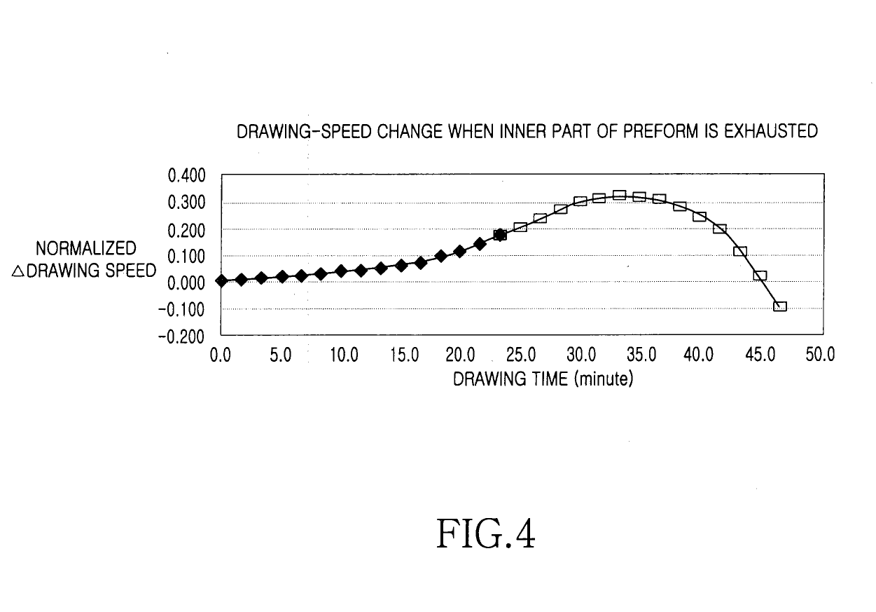

FIG. 9 is a graph illustrating the drawing speed change when the inner part of the preform is exhausted. As shown in this graph, when the feed speed is automatically controlled(A) according to the present invention, the drawing speed becomes almost uniform even after the inner part of the preform begins to be exhausted. On the contrary, when the automatic control is not performed(B), as mentioned above referring to FIG. 4, the slope of the drawing-speed change is not so steep within 25 minutes after the exhaustion of the inner part begins. But, as the amount of the preform gets smaller, the slope sharply increases. When only the innermost part remains, the drawing speed sharply decreases due to insufficient amount of the preform, consequently finishing the optical-fiber drawing process.

As mentioned above, the present invention has an advantage in that the preform feed speed is controlled to stabilize the drawing speed, thereby improving the uniformity of the outer diameter of the optical fiber.

In addition, the present invention has an advantage in that the capstan speed is stabilized to draw the optical fiber when the inner part of the preform is exhausted, thereby improving the quality of the optical fiber, particularly reducing the loss generation ratio.

Further, the present invention has an advantage that the preform feed speed is automatically controlled to allow efficient management of working-manpower.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An apparatus for drawing an optical fiber comprising:
a melting furnace for melting an optical fiber preform;
a preform feeder for feeding the preform to the melting furnace;
a capstan for drawing an optical fiber by pulling the preform from the melting furnace;
an outer diameter measurement unit for measuring an outer diameter of the drawn optical fiber; and
a control unit for controlling the outer diameter of the optical fiber, wherein the control unit includes a calculation unit for receiving a drawing speed signal output from the capstan and calculating a feed speed of the preform.

2. The apparatus as set forth in claim 1, wherein the control unit regulates the outer diameter of the optical fiber by regulating the speed of the capstan according to a signal received from the outer diameter measurement unit indicating a change in the outer diameter of the optical fiber.

3. The apparatus as set forth in claim 1, wherein the calculation unit calculates a slope of the drawing speed during a previously arbitrary period of time and obtains an expected drawing speed of a future arbitrary time period by using the calculated slope, and estimating a compensation value according to a difference between the present drawing speed and a target drawing speed as well as a compensation value according to a difference between the present drawing speed and the expected drawing speed of the arbitrary time later, and calculates the preform feed speed based on the estimated compensation values.

4. The apparatus as set forth in claim 3, wherein the previously arbitrary time period includes a period prior to an automatic feed by the preform feeder.

5. A method of controlling a feed speed of an optical fiber preform, comprising the steps of:
(a) storing data representing a drawing speed of an optical fiber at intervals of a sampling period;
(b)checking a result as to whether the present drawing speed is in one of (i) a stable drawing speed range and (ii) an unstable drawing-speed range;
(c) beginning an automatic control of a preform feed speed when the check result indicates that the perform speed is in the unstable drawing-speed range;
(d) obtaining a recent drawing-speed change tendency within a predetermined period of time based on the stored drawing speed data;
(e) obtaining an expected deviation of the drawing speed of a subsequent arbitrary time based on the recent drawing-speed change tendency;
(f) obtaining a compensation value of the preform feed speed based on the expected value;
(g) obtaining a modification value of the preform feed speed by modifying the compensation value so as to accelerate the drawing speed toward the stable drawing-speed range; and
(h) adding or subtracting the modification value of the preform feed speed to or from a target speed.

6. The method as set forth in claim 5, wherein in the step (d) includes classifying the speed tendency into five types comprising (i) long-period acceleration, (ii)short-period acceleration, (iii) uniform speed, (iv)short-period deceleration, and (v) long-period deceleration.

7. The method as set forth in claim 6, wherein in step (e), the expected deviation of the drawing speed of the subsequent arbitrary time is determined for each tendency type based on each of the following equations, respectively:
in a case of long-period acceleration, V={(D−D2)×2+D2}−T;
in a case of short-period acceleration, V={(D−D1)×3+D1)}−T;
in a case of uniform speed, V=(D−T)×3;
in a case of short-period deceleration, V={(D−D1)×3+D1}−T; and
in a case of long-period deceleration, V={(D−D2)×2+D2}−T,
wherein “V” denotes the expected deviation, “D” the present drawing speed, “D1” a drawing speed of a time t1 ago, and “D2” a drawing speed of a time t2 ago.

8. The method as set forth in claim 5, wherein the compensation value of the preform feed speed in step (f) is determined by the following equation:
CV=(Df/Dp)²×2V=[{Dp√(Sp/(Sf×1000))}/Dp]²×2V=(Sp×2V)/(Sf×1000),
wherein “Df” denotes an outer diameter of a drawn optical fiber, “Dp” an outer diameter of the preform, “Sf” the drawing speed of the optical fiber, and “CV”the compensation value of the preform feed speed.

9. The method as set forth in claim 6, wherein the modification value of the preform feed speed in step (g) is determined by the following equation:
CS=(CV/3)^{2,}
wherein “CV” denotes the compensation value of the preform feed speed, and “CS” the modification value of the preform feed speed.

10. The method as set forth in claim 5, wherein step (h) comprises that, the preform feed speed is classified to be transmitted so as to prevent an abrupt change of the preform feed speed.

11. The method as in claim 9, wherein in the step of adding or subtracting the modification value of the preform feed speed to or from the target speed, the preform feed speed is classified to be transmitted so as to prevent an abrupt change of the preform feed speed.

12. The method as set forth in claim 10, wherein the classifying transmission procedure comprises:
a first step of obtaining a deviation by subtracting the present preform feed-speed from the target speed;
a second step of maintaining the present feed speed as it is when the obtained deviation is in a predetermined range from a negative predetermined value to a positive predetermined value; adding the negative predetermined value to the present feed speed when the obtained deviation is less than the negative predetermined value, and adding the positive predetermined value to the present feed speed when the obtained deviation is more than the positive predetermined value; and then determining the added present feed speed as the present feed speed; and
a third step of repeating the first and second steps until the preform feed speed reaches the target speed.
